(19) United States
(12) Patent Application Publication
(10) Pub. No.: US 2006/0085674 A1
(43) Pub. Date: Apr. 20, 2006

(54) Method and system for storing data

(75) Inventor: Srikanth Ananthamurthy, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/240,481

(22) Filed: Oct. 3, 2005

(30) Foreign Application Priority Data
Oct. 2, 2004 (GB) 0421946.5

(51) Int. Cl. G06F 11/00

(52) U.S. Cl. 714/6

(57) ABSTRACT

The present invention relates to methods for storing data and relates to a method for storing a plurality of stripes across a plurality of disks; wherein each stripe is comprised of a plurality of segments, wherein each segment is comprised of a first data chunk, a second data chunk, and a parity chunk being the parity of the first and second data chunks, and wherein all the chunks within a segment are stored on separate disks. In a preferred embodiment, each stripe includes at least one spare chunk.

### FIELD OF INVENTION

The present invention relates to a method and system for storing data. More particularly, but not exclusively, the present invention relates to a method and system for storing data over multiple disks to provide for redundancy.

### BACKGROUND OF THE INVENTION

RAID is the most popular technology being used to provide data availability and redundancy in storage disk arrays. There are a number of RAID levels defined and used in the storage industry. The primary factors that influence the choice of a RAID level are data availability, performance and capacity.

RAID1 (and RAID1+RAID0) and RAID5 have emerged as the most popular RAID levels that are being used in the disk arrays. RAID1 provides redundancy by mirroring the data. RAID5 maintains the data across a stripe of disks and maintains redundancy by calculating the parity of the data and storing the parity information.

RAID1 provides:
good data availability (can sustain N/2 disk failures)
average write performance (2 writes required for each write request)
poor usable capacity (N/2 usable capacity for N disks)

RAID5 provides:
poor data availability (can sustain 1 disk failure)
poor write performance (at most 4 I/Os required for each write request)
good usable capacity (N-1 usable capacity for N disks)

RAID1 provides complete redundancy to user data by mirroring data for one disk using an extra disk. While RAID1 provides good data availability, it has provides poor disk capacity. Users have only half the total capacity of the disks to store data.

RAID5 maintains one parity disk for a set of disks. RAID5 stripes data and parity across the set of available disks. If a disk fails in the RAID5 array, the failed data can be accessed by reading all the other data and parity disks. This way, RAID5 can sustain one disk failure and still provide access to all the user data. RAID5 has two main disadvantages—when a write is requested of an existing data chunk in the array stripe, both the data chunk and the parity chunks must be read and written back. This results in four I/Os for each write operation. Consequently this could develop into a performance bottleneck, especially in enterprise level arrays. The other difficulty with RAID5 is that when a disk fails, all the remaining disks have to be read to rebuild the data from the failed disk and re-create it on the spare disk. This recovery operation is called “rebuilding” and takes some time to complete. In addition, during the time that the rebuild is happening, the array is exposed to potential data loss if another disk fails.

It is an object of the present invention to provide a method and system for storing data which overcomes or at least ameliorates some of the disadvantages of the above methods, or to at least provide a useful alternative.

### SUMMARY OF THE INVENTION

According to a first aspect of the invention there is provided a method for storing a plurality of stripes across a plurality of disks; wherein each stripe is comprised of a plurality of segments, wherein each segment is comprised of a first data chunk, a second data chunk, and a parity chunk being the parity of the first and second data chunks, and wherein all the chunks within a segment are stored on separate disks.

Preferably each stripe also includes at least one spare chunk. It is further preferred that the spare chunks are hot spares in that they are distributed across all the disks.

It is preferred that no one disk of the plurality of disks contains a number of parity chunks significantly greater than the majority of the disks.

In one embodiment a segment from each stripe may be distributed across only three of the disks. It is then preferred that the parity chunks of the segments are distributed evenly across those three disks.

It is preferred that the method includes the step of, when a disk fails, rebuilding the failed disk. It is further preferred that this step includes the following sub-steps:
i) for each stripe, recalculating the disk chunk using the other chunks within the corresponding segment on that stripe; and
ii) storing the recalculated disk chunk in a spare chunk on the corresponding stripe.

According to another aspect of the invention there is provided a method of storing a plurality of stripes across a plurality of disks, wherein each stripe is comprised of a plurality of data chunks, a parity chunk which is the parity of all the data chunks, and a mirror chunk which is the mirror of one of the data chunks, and wherein all the chunks within a stripe are stored on separate disks.

In one embodiment the data chunk that is mirrored is the data chunk which is most recently accessed within the stripe. Preferably, the data chunk that is mirrored is the data chunk which has been consecutively accessed within the stripe a specified number of times.

Each stripe may include a plurality of mirrored data chunks.

Preferably each stripe includes at least one spare chunk.

It is preferred that the method includes the step of, when a disk fails, rebuilding the failed disk, which includes the sub-steps of:
i) for each stripe, if the chunk on the failed disk is a data chunk which is mirrored then copying the mirror in the stripe to a spare chunk within the stripe;
ii) for each stripe, if the chunk on the failed disk is a data chunk which is not mirrored then calculating a replacement data chunk using the other data chunks and the parity chunk in the stripe, and storing the replacement data chunk within a spare chunk within the stripe; and
iii) for each stripe, if the chunk on the failed disk is the parity chunk then calculating a new parity chunk using the other data chunks, and storing the replacement parity chunk within a spare chunk within the stripe.

It is preferred that no one disk of the plurality of disks contains a number of parity chunks significantly greater than the majority of the disks.

According to another aspect of the invention there is provided a system for storing data, including:
a processor arranged for storing a data chunk within a segment on a disk, calculating a parity chunk for the data chunk and a second data chunk within the segment, and storing the parity chunk in the segment on a disk; and
a plurality of disks arranged for storing a plurality of stripes, each stripe including a plurality of segments, each segment including two data chunks and a parity chunk; wherein all the chunks within a segment are stored on separate disks.

According to another aspect of the invention there is provided a system for storing data, including:
a processor arranged for storing a plurality of data chunks within a stripe on a disk, calculating a parity chunk for all the data chunks within the stripe, storing the parity chunk within the stripe on a disk, selecting one of the data chunks to be mirrored, and storing the selected data chunk within the stripe on a disk; and
a plurality of disks arranged for storing a plurality of stripes, each stripe including a plurality of data chunks, a parity chunk, and a mirror of one of the data chunks; wherein all the chunks within a stripe are stored on separate disks.

According to another aspect of the invention there is provided computer software for storing data, including:
a module arranged for storing a data chunk within a segment on a disk, calculating a parity chunk for the data chunk and a second data chunk within the segment, and storing the parity chunk in the segment on a disk; wherein the segment is one of a plurality of segments all stored within one of a plurality of stripes across a plurality of disks and wherein all the chunks within a segment are stored on separate disks.

According to another aspect of the invention there is provided computer software for storing data, including:
a module arranged for storing a plurality of data chunks within a stripe on a disk, calculating a parity chunk for all the data chunks within the stripe, storing the parity chunk within the stripe on a disk, selecting one of the data chunks to be mirrored, and storing the selected data chunk within the stripe on a disk; wherein all the chunks within the stripe are stored on separate disks.

### BRIEF DESCRIPTION OF THE DRAWINGS

Embodiments of the invention will now be described, by way of example only, with reference to the accompanying drawings in which:

FIG. 1: shows a disk array containing data stored according to an embodiment of the invention where each segment is confined to three disks.

FIG. 2: shows a disk array containing data stored according to an embodiment of the invention where the segments are not confined to three disks.

FIG. 3: shows a disk array containing data stored according to an embodiment of the invention where the spare chunk is a hot spare.

FIG. 4: shows a disk array containing data stored according to a second embodiment of the invention.

FIG. 5: shows a disk array containing data stored according to a second embodiment of the invention where each stripe includes two mirror chunks.

FIG. 6: shows a stripe from a disk array containing data stored according to a second embodiment of the invention before an active data chunk is written.

FIG. 7: shows a stripe from a disk array containing data stored according to a second embodiment of the invention after an active data chunk is written.

FIG. 8: shows a stripe from a disk array containing data stored according to a second embodiment of the invention after the active data chunk has changed.

FIG. 9: shows a diagram of how embodiment of the invention could be deployed on hardware using a disk array within a single device.

FIG. 10: shows a diagram of how embodiment of the invention could be deployed on hardware using a disk array within a server on a network.

### DETAILED DESCRIPTION OF PREFERRED EMBODIMENTS

The present invention relates to two methods for storing data on a disk array to provide redundancy for the data.

The first method distributes a first data chunk, a second data chunk, and a parity chunk for both data chunks over separate disks. The first method will be referred to as SP RAID5 (Split Parity RAID5).

The second method distributes multiple data chunks, a parity chunk, and a chunk mirroring one of the data chunks over a plurality of disks. Generally the method mirrors the most frequently used data chunk. The second method will be referred to as R1R5 (RAID1 assisted RAID5).

Split Parity RAID5

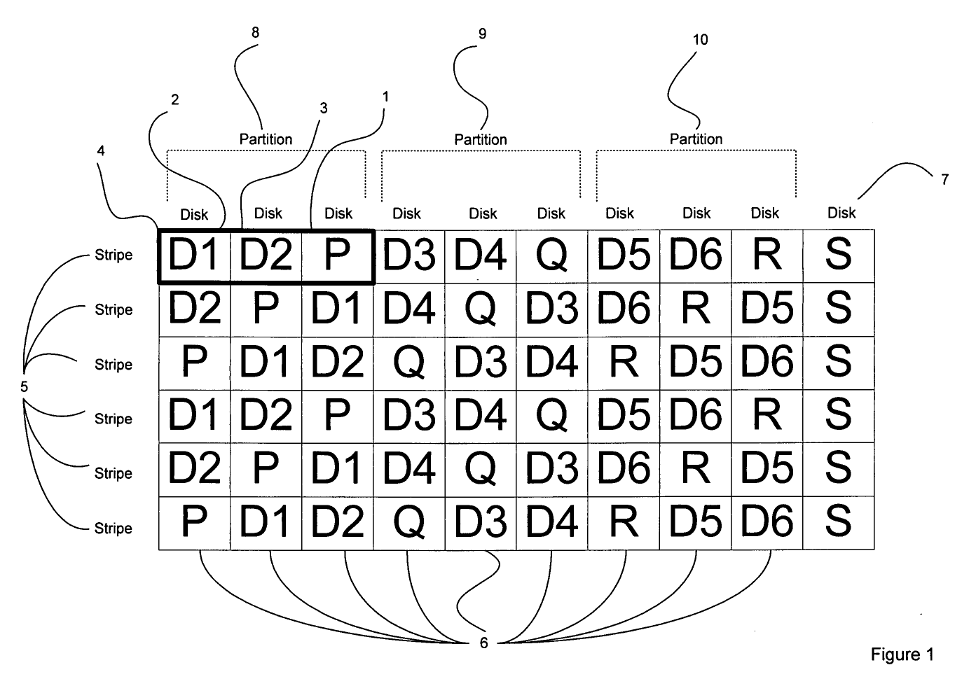

Referring to FIGS. 1 to 3, SP RAID5 will be described. SP RAID5 is similar to RAID5 in terms of calculating parity. However, it maintains more than one parity chunk in a stripe. One parity chunk 1 is maintained for a pair of data chunks 2 and 3. The set of two data chunks and their parity is called a segment 4. In essence, every stripe 5 across the disks 6 is split into segments. This results in, effectively, one disk for parity for every two disks for data. Maintaining a single parity disk for a set of two data disks provides significant benefits compared to RAID5 in terms of rebuild and write performances.

SP RAID5 provides a middle path solution of RAID1 and RAID5 in terms of performance and redundancy.

FIG. 1 shows an example of an SP RAID5 system with nine data disks 6 and a spare disk 7. In this first implementation of the invention the disks have been split into parity partitions 8, 9 and 10, each segment within every stripe 5 is associated with a parity partition and the chunks within each segment are distributed only within the parity partition for that segment. For example all the chunks within segment 4 fall within partition 8. Each partition encompasses three disks.

Each stripe 5 contains the following chunk locations on separate disks: D1 and D2 are data chunks, P is the parity of these two chunks; D3 and D4 are data chunks, Q is the parity of these two chunks; D5 and D6 are data chunks, R is the parity of these two chunks; and S is the hot spare chunk.

Each of the D1+D2+P segments is associated with partition 8. Each of the D3+D4+Q segments is associated with partition 9. Each of the D5+D6+R segments is associated with partition 10.

It will be appreciated that a single disk within a partition may contain all the parity chunks for associated segments. However, it should be noted that whenever a write is made to either of the data chunks of a segment within a parity partition, the parity chunk is also updated. Therefore any write to the partition involves a write to a disk containing the parity chunk. If a single disk contains all the parity chunks for associated segments, then that disk will be almost two times overloaded in use compared to the other two disks. It is preferred, then, that the parity chunk is rotated across all three disks to balance out this load.

The implementation described in FIG. 1 does not support active hot spares. Active hot spares are spare chunks that are distributed across all the disks. As this implementation partitions the disks inside the stripe for parity purposes, providing an active hot spare is not feasible. Providing hot spares for each three disk partition is possible but will result in a requirement of one spare disk for every three disks.

Conventional RAID5 arrays have dedicated spare disks. One or more disks are ear marked as spares and they will not contain any data during the normal operations. When a data disk fails, the rebuild operation starts. The rebuild operation will read all the other data disks and the parity disk and construct the data that was present on the failed disk. The constructed data is then written on the spare disk. The disadvantage with dedicated spare disks are: (i) during rebuild operation, all stripes will be writing to the spare disk so writes can queue up on the spare disk and (ii) since the spare disk is unused during normal operations, it is possible for the spare disk to have gone bad for some reason which will only be apparent when an attempt is made to use the spare disk for a rebuild.

The solution for these problems is distributed sparing (active hot spares). Instead of having separate spare disks, the disk space corresponding to the spare disk is spread across all the disks (similar to how parity is distributed in RAID5). This eliminates the two disadvantages of dedicated sparing mentioned above.

In the present implementation of SP RAID5 a dedicated spare disk 7 has been used and the implementation will be exposed to the two disadvantages mentioned above. However, constant scrubbing can eliminate the second disadvantage (for a small processing overhead). The effect of the first disadvantage is diminished because the rebuild operation affects only the parity partition and not the entire stripe (as in RAID5). When a disk in a parity partition fails, only two more disks have to be read to construct the failed data (instead of n−1, as in RAID5). So the rebuild will complete faster and the disks in other parity partitions are not affected by the rebuild process.

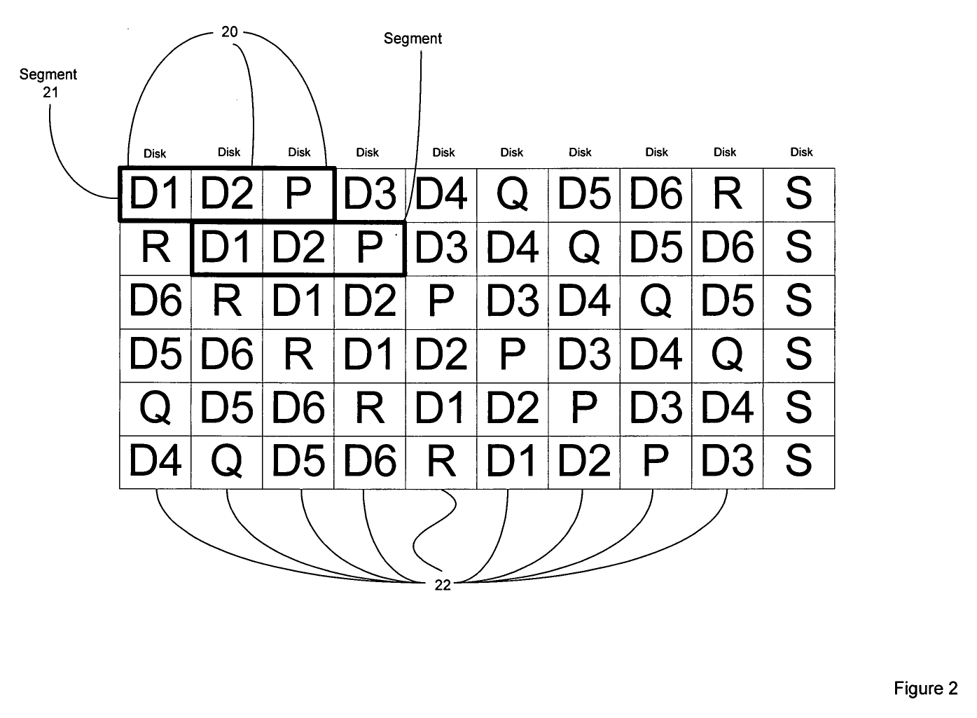

A second implementation of the invention will be described with reference to FIG. 2.

In this implementation of the invention there are no partitions and chunks 20 within a segment 21 may be distributed across any of the disks 22.

This implementation has the disadvantage that five disks (rather than three disks) are required for a rebuild. In addition, a system to keep track of which data chunks and parity chunks are on which disk will be required. The distribution of the chunks may become difficult to track after a rebuild.

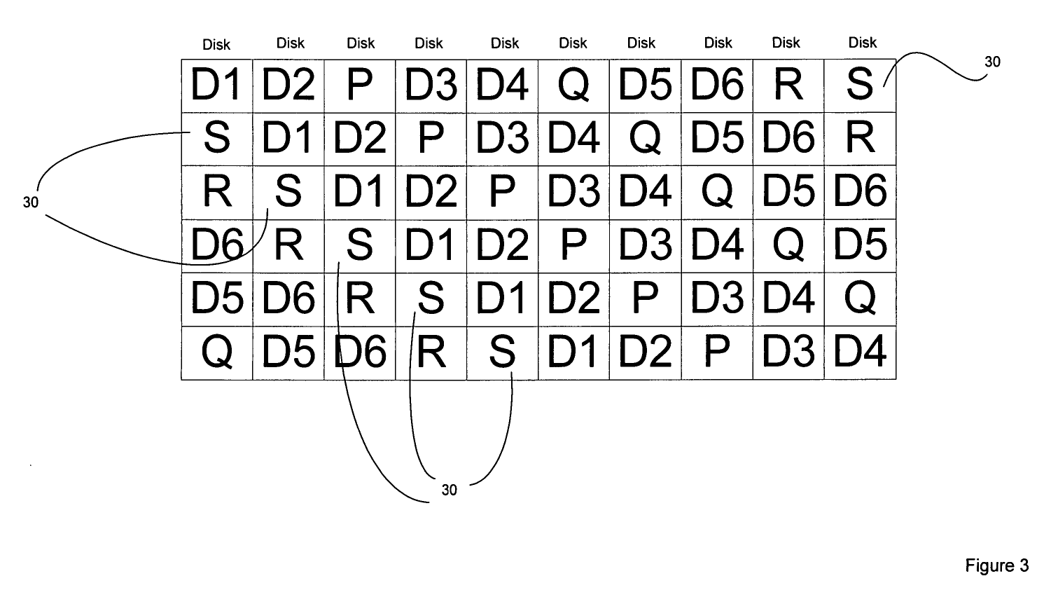

However, a benefit of distributing the chunks across all disks is that the spare chunk can be distributed as well and, thus, become a hot spare. This means that the disadvantages of a dedicated spare disk are avoided. An implementation of the invention in which the spare chunks 30 are distributed across all the disks as a hot spare is shown in FIG. 3.

For N disks, (excluding the hot spare disk), SP RAID5 provides usable data capacity of 2N/3 disks (where N=I*3, where I is a natural number>0).

In comparison, RAID5 provides N−1 disks capacity and RAID1 provides N/2 disks capacity.

SP RAID5 can survive N/3 disk failures.

SP RAID5 has improved performance in rebuild and write operations over RAID5. SP RAID5 has improved storage efficiency over RAID1.

A rebuild operation occurs when a disk fails in the disk array. The rebuild operation reconstructs the data that was on the failed disk onto the hot spare disk. In RAID5, all the remaining data disks and the parity disk are read to reconstruct the failed data. Therefore, N−1 disks are read to reconstruct the failed data. In SP RAID5, when the disk fails, only two other disks need to be read in the first implementation of the method (and four other disks in the second implementation of the method). This greatly improves the rebuild performance. Also (for the first implementation) if more than one disk fails in the disk array (in different parity partitions) and if more than one hot spare is configured in the system, then rebuild can execute in parallel in the affected parity partitions.

While the performance of SP RAID5 is similar to RAID5 for read operations, the performance is superior for write operations.

For example, the following write operations are applicable to RAID5 technology:
Initial Stripe Write (ISW);
Stripe Extending Write (SEW); and
Read Modify Write (RMW).

ISW is a write to the first data chunk in an empty stripe. The data is written to the data chunk and also the parity chunk (there is no need to calculate parity as there are no other data chunks in the stripe). ISW is as efficient as a RAID1 write. ISW requires two writes:
i) Write new data
ii) Write new parity

SEW is a write to subsequent data chunks in the stripe until the stripe is full. SEW requires one read, two writes and one parity computation:
i) Read old parity
ii) Compute new parity (old parity+new data)
iii) Write new data
iv) Write new parity

RMW is a write to existing data in the stripe. RMW requires two reads, two writes and two parity computations:
i) Read old data
ii) Read old parity
iii) Compute intermediate parity (old data+old parity)
iv) Compute new parity (intermediate parity+new data)
v) Write new data
vi) Write new parity

The ‘+’ symbol used within any of above steps denotes an XOR operation to calculate the parity.

As shown above, the ISW and SEW write methods are significantly faster than the RMW write method. RMW is in fact the main disadvantage of RAID5 technology.

SP RAID5 performs better than conventional RAID5 for ISW writes. In conventional RAID5, there is one ISW in each stripe whereas in SP RAID5, there are N/3 ISW writes per stripe. There is because there is one ISW write for each of the segments in the stripe.

Conventional RAID5 performs better than SP RAID5 for SEW writes. In conventional RAID5, there are N−1 SEW writes whereas in SP RAID5, there are N/3 SEW writes.

SP RAID5 level provides better performance in the case of RMW writes. RMW for SP RAID5 will require one read, two writes and one parity computation:
i) Read other data disk
ii) Compute new parity (other data+new data)
iii) Write new data
iv) Write new parity

Compared to conventional RAID5, SP RAID5 saves on one read and one parity computation for RMW.

Effectively RMW in SP RAID5 gives the same performance as SEW in conventional RAID5.

SP RAID5 has the following apparent disadvantage:
Restrictions in the dynamic addition of disks. As a segment requires three disks, adding a single disk to the disk array will not increase the usable capacity in the disk array dynamically. Once three disks are added, a new segment can be formed and the usable capacity increased. However, the additional disks could be used as additional spare disks, until there are enough for a full segment.

RAID1 Assisted RAID5

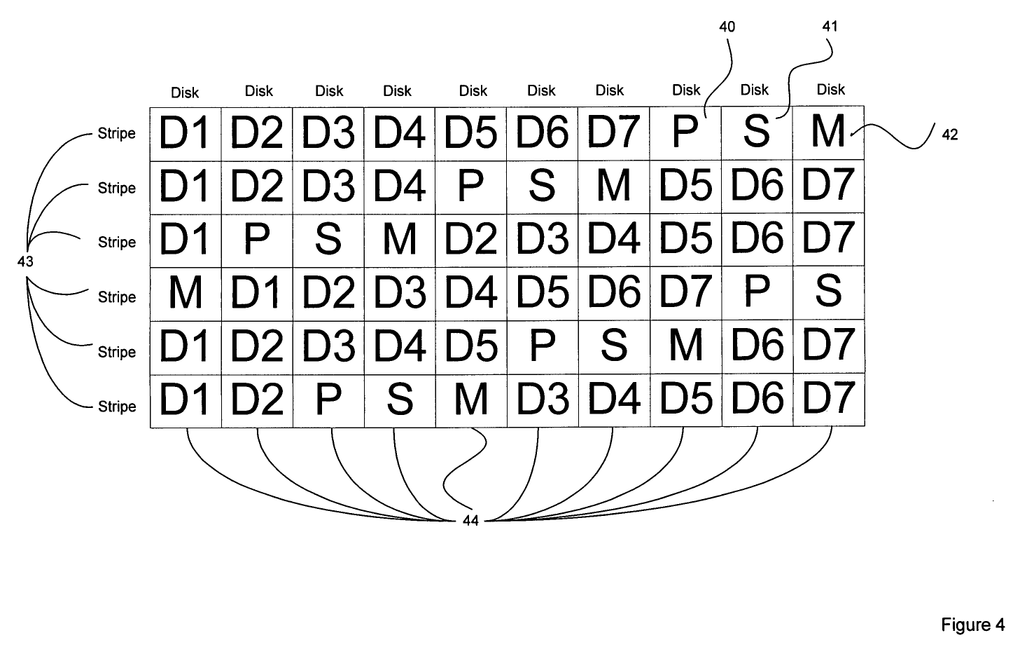

Referring to FIGS. 4 to 8, R1R5 will be described. R1R5 is similar to RAID5 in terms of calculating parity. However it also maintains one or more chunks (active chunks) in the stripe in RAID1 level (mirroring). R1R5 keeps the active chunk/s in RAID1 and the remaining chunks in RAID5. This technology provides benefits in performance compared to RAID5 for write and rebuild.

Apart from the parity chunk 40 and the hot spare chunk 41, R1R5 keeps aside another chunk 42 in each data stripe 43. This chunk will be referred to as the “backup” chunk 42. The backup chunk 42 is striped across all the disks 44 similar to the parity chunk in RAID5.

FIG. 4 shows an implementation of R1R5 across a ten disk array. Each stripe 43 contains the following chunk locations: D1 to D7 are data chunks; P is the parity for the data chunks; S is the hot spare chunk; and M is the backup chunk.

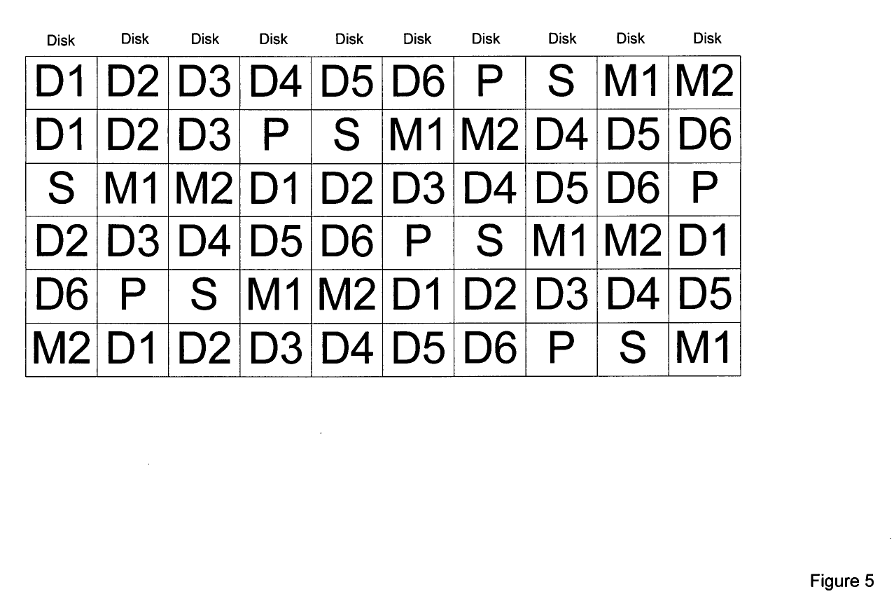

In this implementation only one chunk in each stripe will be marked as active and saved in RAID1 mode in the stripe (i.e. within the backup chunk as well). The method can be extended for more than one active chunk as shown in FIG. 5 where M1 and M2 are the backup chunks corresponding to two active chunks.

Assuming the case of one active chunk, for N disks, (excluding the hot spare disk), R1R5 provides usable data capacity of N−2 disks. In comparison, RAID5 provides N−1 disks capacity and RAID1 provides N/2 disks capacity.

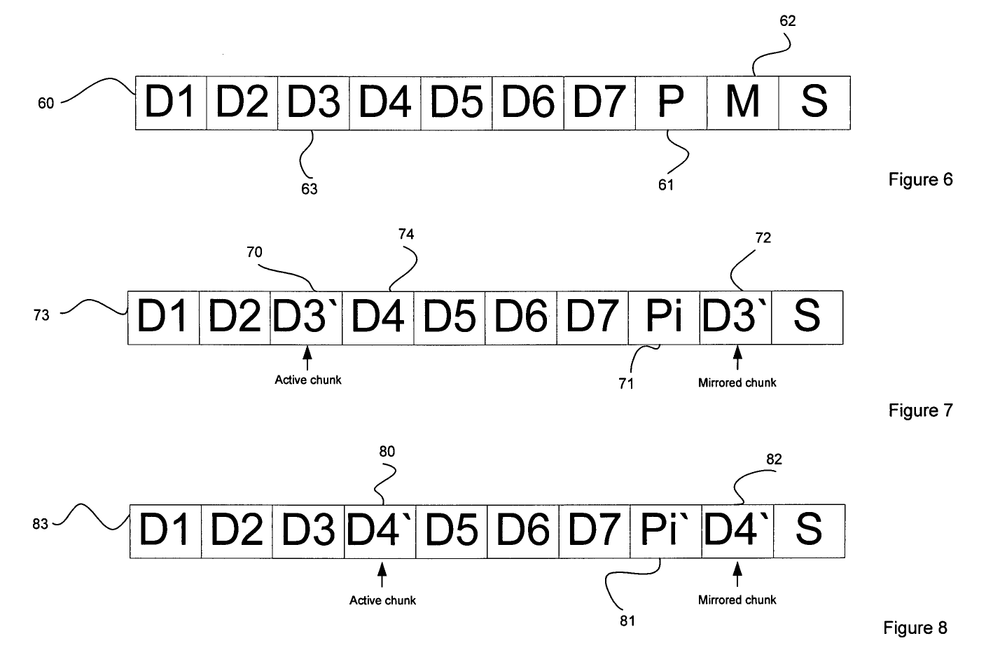

With reference to FIGS. 6 to 7, the operation of R1R5 will be described.

Initially all the chunks in a stripe 60 are empty. As data fills up the stripe, D1 to D7 will be filled and parity for all the data will be calculated and stored in P61. The backup chunk M62 will be empty at this stage.

When the array is in optimal condition (all disks are working fine), the spare chunk could be used as the backup chunk. This improves the storage efficiency of R1R5. When a disk fails, the disk storage system can revert to conventional RAID5 and the spare space can be reclaimed for rebuilding data from the failed disk. The disadvantage of this option is that time taken to rebuild the data will increase. Therefore it is preferred that the spare chunk is maintained and space for the backup chunk is achieved using an extra disk. When some of the data chunks in the stripe are unused, conventional RAID5 write methods can be used. Once all the data chunks are full and further writes are received, RAID5 would use the Read-Modify-Write (RMW) method. RMW is a costly write method as it involves many I/Os to achieve one write operation, as described below:
i) Read old data
ii) Read old parity
iii) Compute intermediate parity (old data+old parity)
iv) Compute new parity (intermediate parity+new data)
v) Write new data
vi) Write new parity

RMW requires two reads, two calculations and two writes. The performance of write is poor and this forms one of the biggest drawbacks of RAID5 technology.

In R1R5, when a write comes to a particular data chunk (for example D3 63), the following write technique will be used:
i) Read old data 63 [read D3]
ii) Read old parity 61 [read P]
iii) Compute intermediate parity (old data+old parity) [Pi=P+D3]
iv) Write new data 70 [write D3′]
v) Write intermediate parity 71 [write Pi]
vi) Write copy of data to backup chunk 72 [write D3′]

After the write, the resulting data stripe 73 is shown in FIG. 7.

The parity chunk 71 contains an intermediate parity, which is the parity of all the data chunks except D3′ 70. D3′ 70 is mirrored into the backup chunk 72 and is in RAID1 level.

To illustrate how the intermediate parity Pi 71 contains parity of all the other data chunks in the array, initially P=D1+D2+D3+D4+D5+D6+D7. When new data to D3′ 70 (and the backup chunk D3′ 72) arrives, the intermediate parity Pi is:

$$\begin{matrix}Pi + D3 = D1 + D2 + D3 + D4 + D5 + D6 + D7 + D3 \\ = D1 + D2 + D4 + D5 + D6 + D7\end{matrix}$$

Note: ‘+’ denotes XOR operation and in XOR operations, a+a=0 and a+0=a.

As shown above the write technique requires two reads, one calculation and three writes. This is more than RAID5 RMW technique requires. However, the benefit of the invention occurs when further writes are made to D3′. If further writes are made to D3′, no reads or calculations are required and two writes are made—one to the data chunk D3′ and the other to the backup chunk. Consider a set of ten writes made to the data chunk D3′, the normal RMW technique would have required twenty reads, twenty calculations and twenty writes. R1R5 requires two reads, one calculation and twenty-one writes (two reads, one calculation and three writes for the first write and two writes each for the next nine writes). Clearly there is a benefit in performance when multiple consecutive writes in a stripe are made to a single data chunk. A sequential write workload will have improved performance with the R1R5 method. Random workloads where the randomness is limited to the size of data chunk will also benefit from this method. If the randomness of the workload spreads across multiple chunks within the stripe, then this method will be inferior to RAID5 in performance.

Sequential workload can be laid out in the disk array in such a way that the active chunk is not changed for every write. For example, the data for a LUN (Logical Unit) can be mapped such that LBA (Logical Block Address) 0-99 are on stripe one, LBA 100-199 are on stripe two, LBA 200-299 are on stripe three and so on. Then a sequential write workload on the LUN would first touch stripe one, transitioning from an unused backup chunk to an active backup chunk. The next set of writes would do the same on stripe two, then on to stripe three and so on.

By way of background, a write to any device is of the form <device, start address, offset>. “Start address” is the point at which the write should start on the device and “offset” is the size of the write. LBA corresponds to start address. In a disk array I/Os (reads and writes) are sent to virtual disks (LUN, LBA, offset). The disk array in turn converts this into writes to multiple physical disks (disk number, LBA, offset). For example, a single write to a LUN configured in RAID1 will result in writes to 2 physical disks. A LUN is SCSI term for a virtual disk that is built in the disk array. Virtual disks are not bound by the size of the physical disks and sit above the RAID layer.

The sequential workload may allow a background migration of data from active chunk (mirroring) to inactive chunk (parity based replication) and vice versa. For example, while the data is being updated on the first stripe, second and subsequent stripes can prepare themselves for the upcoming write by making the chunk that will be written to an active chunk.

The background migration can be applied to chunks within a single stripe as well. If a sequential write workload is identified, after the first write, the next chunk in the stripe can be made the active chunk, ahead of time and in anticipation of the write.

In the example, D3′ 70 was the active chunk in the stripe and the R1R5 method mirrored this chunk and retained the other chunks in RAID5 topology.

If writes to D3 stopped and D4 received writes, then D4 74 will be made the active chunk in the stripe and its data will be mirrored and D3 will move back into the RAID5 topology:
i) Write is made to D4 74
ii) Read old data 74 [read D4]
iii) Read old parity 71 [read Pi]
iv) Determine that change of active chunk is required
v) Read current active chunk 70 [read D3]
vi) Calculate new intermediate parity [Pi′=Pi+D4+D3]
vii) Write new data 80 [write D4′]
viii) Write new intermediate parity 81 [write Pi′]
ix) Write copy of data to backup chunk 82 [write D4′]

FIG. 8 shows the data stripe 83 after the process.

The above process requires three reads, one calculation and three writes. The benefit of the method occurs when subsequent writes are made to D4′ 80.

If the active chunk changes for every write or every couple of writes, then the performance of the write degrades in R1R5. A chunk should remain active for at least three writes for R1R5 to provide benefit. For this reason, it is preferred that R1R5 is implemented as a feature which can set on or off by the end user.

If a particular workload benefits by retaining the RAID5 setup only, then the R1R5 option can be switched off and the disk array will behaves like normal RAID5 array. The backup chunk space can then be used for normal data.

The performance of R1R5 for read is equal or better than the performance of RAID5. For all the non-active data chunks, the read occurs as for RAID5. For the active chunk, read can occur in parallel and hence results in a benefit.

When a disk fails in the array, the rebuild operation can occur as for RAID5. However, for all the stripes which have lost the active chunk or the backup chunk, there will be a benefit in the rebuild performance as well. In RAID5, failed data is regenerated by reading all the other data chunks and the parity chunks. In R1R5, for the stripes that have lost a non-active chunk, the regeneration is the same as RAID5. For the stripe that has lost the active chunk, the rebuild algorithm has to merely read the backup chunk and restore the same. Similarly a backup chunk can be restored using the active chunk. This improves rebuild performance in the array.

As the parity calculations and data redundancy of the active chunk are kept separate, the chances of data corruption due to RAID calculations do not arise. In addition, R1R5 eases the situations surrounding “restore consistency” code paths in RAID5 algorithms. Existing RAID5 algorithms are plagued with complexity in the “restore consistency” path during write operation. Restore consistency refers to restoring the correct data in all the chunks in the stripe and having the correct parity for these data chunks. When a write is made to a chunk in the stripe and if that write fails or the array crashes, the correct data (old or new) needs to be restored and the parity has to be in sync with the saved data in the stripe. Since R1R5 keeps the chunk being written to in RAID1, the parity of the remaining data chunks is kept intact.

RAID logic can be used to maintain information about which is the active chunk in a stripe for all the stripes in the array. It will be appreciated that for each stripe the active chunk could be different. This will require extra logic and metadata space in the RAID implementation.

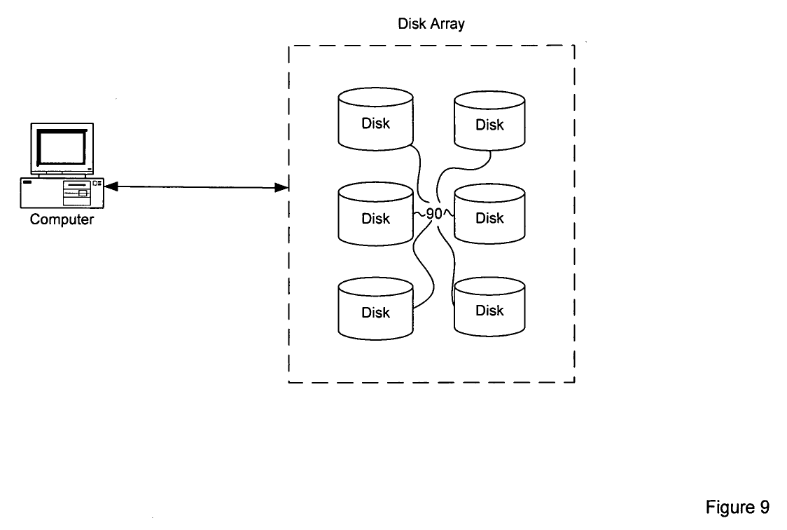

FIG. 9 describes how SP RAID5 or R1R5 can be implemented within a single computer system.

A single computer system is configured with multiple physical disks 90 (the disk array), such as SCSI or SATA, which support the RAID architecture.

The RAID layer is implemented with SP RAID or R1R5, which direct how data is to be stored on the disks and accessed from the disks.

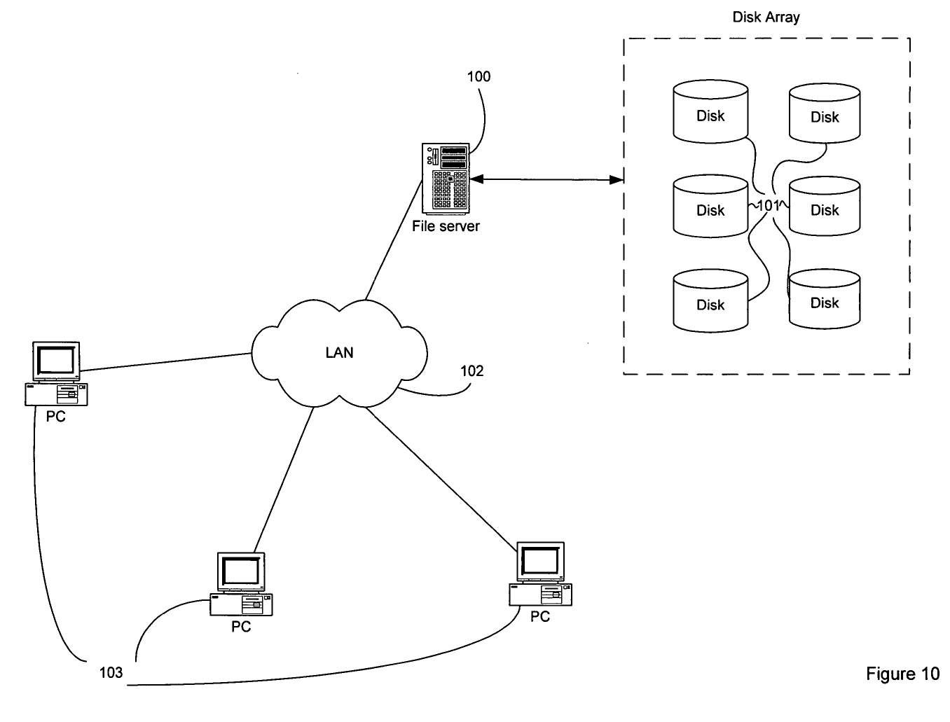

FIG. 10 describes how SP RAID5 or R1R5 can be implemented within a network environment.

A server 100, such as a file server, is configured with multiple physical disks 101 (the disk array) which support RAID architecture.

The RAID layer which manages the disk array is configured with the method of SP RAID5 or R1R5.

The server is deployed on a network 102, such as a LAN, and receives requests to store or retrieve data from multiple computer systems 103 connected to the network.

The RAID layer on the server manages the storage/retrieval of data in relation to the physical disks.

Advantages of the SP RAID5 method of the invention have been described through-out the specification and include improved rebuild performance over RAID5, improved write performance over RAID5 (for both ISW and RMW writes), the ability to sustain up to N/3 disks failures as compared to 1 disk failure for RAID5, and increased storage efficiency over RAID1 (2N/3 usable disks' capacity compared to N/2).

To illustrate the storage benefits, consider a disk array having thirty disks and assume that each disk's capacity is 10 GB. Therefore the total physical capacity of the disk array is 300 GB:
i) RAID5 provides usable capacity of N−1 disks (i.e. 290 GB)
ii) RAID1 provides usable capacity of N/2 disks (i.e. 150 GB)
iii) SP RAID5 provides usable capacity of 2N/3 disks (i.e. 200 GB)

Advantages of the R1R5 method of the invention have also been described through-out the specification and include improved write performance over RAID5 (for most types of workloads), improved rebuild performance over RAID5, improved read performance over RAID5, and increased storage efficiency over RAID1.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departure may be made from such details without departure from the spirit or scope of applicant's general inventive concept.

1. A method for storing a plurality of stripes across a plurality of disks; wherein each stripe is comprised of a plurality of segments, wherein each segment is comprised of a first data chunk, a second data chunk, and a parity chunk being the parity of the first and second data chunks, and wherein all the chunks within a segment are stored on separate disks.

2. A method as claimed in 2 wherein each stripe includes at least one spare chunk.

3. A method as claimed in claim 2 wherein each disk contains at least one spare chunk.

4. A method as claimed in claim 1 wherein for three of the plurality of disks, a segment from each stripe is distributed across only those three disks.

5. A method as claimed in claim 4 wherein the parity chunks of the segments are distributed evenly across the three disks.

6. A method as claimed in claim 1 wherein no one disk of the plurality of disks contains a number of parity chunks significantly greater than the majority of the disks.

7. A method as claimed in claim 1 including the step of, when a disk fails, rebuilding the failed disk.

8. A method as claimed in claim 7 wherein the step of rebuilding the failed disk includes the sub-step of:
for each stripe, recalculating the chunk on the failed disk using the other chunks within the corresponding segment on that stripe.

9. A method as claimed in claim 8 wherein the step of rebuilding the failed disk includes the sub-step of:
storing the recalculated chunk in a spare chunk on the corresponding stripe.

10. A method as claimed in claim 8 wherein the step of rebuilding the disk includes the sub-step of:
storing the recalculated chunk in the parity chunk in the corresponding segment.

11. A method of storing a plurality of stripes across a plurality of disks, wherein each stripe is comprised of a plurality of data chunks, a parity chunk which is the parity of all the data chunks, and a mirror of one of the data chunks, and wherein all the chunks within a stripe are stored on separate disks.

12. A method as claimed in 11 wherein the data chunk that is mirrored is the data chunk which is most recently accessed within the stripe.

13. A method as claimed in 11 wherein the data chunk that is mirrored is the data chunk which is consecutively accessed in the stripe a specified number of times.

14. A method as claimed in claim 11 wherein each stripe includes a plurality of mirrored data chunks.

15. A method as claimed in claim 11 wherein each stripe includes at least one spare chunk.

16. A method as claimed in claim 11 including the step of, when a disk fails, rebuilding the failed disk.

17. A method as claimed in claim 16 wherein the step of rebuilding the disk includes the sub-steps of:
i) for each stripe, if the chunk on the failed disk is a data chunk which is mirrored then copying the mirror in the stripe to a spare chunk within the stripe;
ii) for each stripe, if the chunk on the failed disk is a data chunk which is not mirrored then calculating a replacement data chunk using the other data chunks and the parity chunk in the stripe, and storing the replacement data chunk within a spare chunk within the stripe; and
iii) for each stripe, if the chunk on the failed disk is the parity chunk then calculating a new parity chunk using the other data chunks, and storing the replacement parity chunk within a spare chunk within the stripe.

18. A method as claimed in claim 11 wherein no one disk of the plurality of disks contains a number of parity chunks significantly greater than the majority of the disks.

19. A system for storing data, including:
a processor arranged for storing a data chunk within a segment on a disk, calculating a parity chunk for the data chunk and a second data chunk within the segment, and storing the parity chunk in the segment on a disk; and
a plurality of disks arranged for storing a plurality of stripes, each stripe including a plurality of segments, each segment including two data chunks and a parity chunk; wherein all the chunks within a segment are stored on separate disks.

20. A system as claimed in 19 wherein each stripe also includes at least one spare chunk.

21. A system as claimed in 20 wherein each disk contains at least one spare chunk.

22. A system as claimed in claim 19 wherein for three of the plurality of disks, a segment from each stripe is distributed across only those three disks.

23. A system as claimed in 22 wherein the parity chunks of the segments are distributed evenly across the three disks.

24. A system as claimed in claim 19 wherein no one disk of the plurality of disks contains a number of parity chunks significantly greater than the majority of the disks.

25. A system as claimed in claim 19 wherein the processor is further arranged for rebuilding a failed disk.

26. A system as claimed in claim 25 wherein the processor is further arranged for recalculating the chunk on the failed disk using the other chunks within the corresponding segment and storing the recalculated chunk in a spare chunk on the corresponding stripe.

27. A system for storing data, including:
a processor arranged for storing a plurality of data chunks within a stripe on a disk, calculating a parity chunk for all the data chunks within the stripe, storing the parity chunk within the stripe on a disk, selecting one of the data chunks to be mirrored, and storing the selected data chunk within the stripe on a disk; and
a plurality of disks arranged for storing a plurality of stripes, each stripe including a plurality of data chunks, a parity chunk, and a mirror of one of the data chunks; wherein all the chunks within a stripe are stored on separate disks.

28. A system as claimed in 27 wherein the data chunk is selected on the basis of being the data chunk consecutively accessed within the stripe a specified number of times.

29. A system as claimed claim 27 wherein the processor is further arranged for selecting a second data chunk to be mirrored and storing the second data chunk within the stripe, and wherein each stripe includes a mirror of the second data chunk.

30. A system as claimed in claim 27 wherein each stripe includes at least one spare chunk.

31. A system as claimed in claim 27 wherein the processor is further arranged for rebuilding a failed disk.

32. A system as claimed in claim 31 wherein the processor is further arranged for copying the mirror in the stripe to a spare chunk within the stripe when the chunk on the failed disk is a data chunk which is mirrored;
wherein the processor is further arranged, for calculating a replacement data chunk using the other data chunks and the parity chunk in the stripe and storing the replacement data chunk within a spare chunk within the stripe, when the chunk on the failed disk is a data chunk which is not mirrored then; and
wherein the processor is further arranged, for calculating a new parity chunk using the other data chunks and storing the replacement parity chunk within a spare chunk within the stripe, when the chunk on the failed disk is a parity chunk.

33. A system as claimed in claim 27 wherein no one disk of the plurality of disks contains a number of parity chunks significantly greater than the majority of the disks.

34. Computer software for storing data, including:
a module arranged for storing a data chunk within a segment on a disk, calculating a parity chunk for the data chunk and a second data chunk within the segment, and storing the parity chunk in the segment on a disk; wherein the segment is one of a plurality of segments all stored within one of a plurality of stripes across a plurality of disks and wherein all the chunks within a segment are stored on separate disks.

35. Computer software for storing data, including:
a module arranged for storing a plurality of data chunks within a stripe on a disk, calculating a parity chunk for all the data chunks within the stripe, storing the parity chunk within the stripe on a disk, selecting one of the data chunks to be mirrored, and storing the selected data chunk within the stripe on a disk; wherein all the chunks within the stripe are stored on separate disks.

36. A system arranged for performing the method of claim 1.

37. Computer software arranged for performing the method of claim 1.

38. A computer readable medium having stored thereon computer software as claimed in claim 34.
